(19) United States
(12) Patent Application Publication
(10) Pub. No.: US 2009/0035545 A1
(43) Pub. Date: Feb. 5, 2009

(54) POLYETHYLENE FILMS WITH IMPROVED BUBBLE STABILITY

(75) Inventors: Gerhard Guenther, Seabrook, TX (US); Cyril Chevillard, Dickinson, TX (US); Shannon Hoesing, Houston, TX (US)

Correspondence Address: FINA TECHNOLOGY INC, PO BOX 674412, HOUSTON, TX, 77267-4412, US

(73) Assignee: FINA TECHNOLOGY, INC., Houston, TX (US)

(21) Appl. No.: 11/830,298

(22) Filed: Jul. 30, 2007

(51) Int. Cl. B32B 25/08; C08K 5/14; C08L 23/06

(52) U.S. Cl. 428/219; 428/334; 524/280; 524/320; 524/394

(57) ABSTRACT

This invention relates to high density polyethylene blown films having good barrier properties and improved processing characteristics. The method incorporates the use of peroxide which results in improved bubble stability without sacrifice in barrier properties. The polyethylenes have a density greater than about 0.950 g/cc, are relatively narrow in molecular weight distribution MWD (in the range of from about 2.0 to about 6.5), and are of medium molecular weight. In an embodiment, the films also have a rheological breadth parameter, a, that has been reduced by at least about 5%, but not more than 45%, by addition of a peroxide to the polyethylene. The addition of peroxide improves processability without sacrificing strength and barrier properties such as oxygen transmission rate.

### FIELD

This invention relates to high density polyethylene blown films that having good barrier properties and improved processing characteristics. The method incorporates the use of peroxide which results in improved processing characteristics such as melt strength, bubble stability and gauge uniformity without sacrificing barrier properties or optics.

### BACKGROUND

This invention relates to monolayer or multi-layer blown film extrusion. In blown film extrusion, the resin is first melted by subjecting it to shear, heat and pressure inside the barrel of an extruder and forcing the melted resin through a die. The melt from the extruder is typically distributed to the bottom or side of the die via ports. The melt from the individual ports is uniformly distributed circumferentially in the die through spiral grooves around the surface of a mandrel inside the die and extruded through the die opening in the form of tube.

After the bubble is formed, it is collapsed and the resulting film layers are drawn through nip rolls, idler rolls and various winders and finishing rolls for packaging or subsequent conversion to finished products.

Although the blown film extrusion process can be complex, most problems occur during bubble formation. This is because the highest demand is required of the resin formula during bubble formation. The resin formula and physical characteristics along with the equipment characteristics and process conditions produce films with specific physical properties and dimensions, which vary upon such conditions. For a given resin, the extrusion throughput, die gap and die diameter in combination with the drawdown ratio, blow up ratio (BUR) and frost line height result in a film with specific optical properties like gloss and haze as well as physical properties such as strength, toughness as defined by tensile properties, dart and tear and the barrier properties of the film, i.e., the ability of water, moisture, odors etc. to penetrate the film. It can be difficult to quantify the overall stability of the bubble. Ideally, it will remain still as it is blown and cooled resulting in a film with constant gauge. However, the bubble can be so unstable that excessive film gauge variation will occur, or in extreme cases, the film will break. Thus, a successful process is highly dependent on the resin characteristics.

Polyethylene is generally categorized in terms of density ranges such as high density polyethylene (HDPE, density 0.941 g/cm³ or greater), medium density polyethylene (MDPE, density between 0.941 and 0.927 g/cm³), and linear low density polyethylene (LLDPE, density 0.910-0.926 g/cm³). See, e.g., ASTM D4976-98. HDPE is commonly used to make blown films for use in applications such as food packaging, trash bags, merchandise bags and grocery sacks.

Density, molecular weight distribution (MWD), and melt index (MI2) are three key properties of HDPE used in blown film manufacture. Most HDPE films are made from broad MWD HDPE because this type of HDPE is much easier to process, i.e., extrusion and bubble stability are better and more forgiving. However, such films usually have poor barrier properties. Similarly, HDPEs with low MI2 generally have better bubble stability but may, in some cases, exhibit melt fracture and have poor barrier properties.

There is a need therefore to improve bubble stability in narrow molecular weight distribution high melt index HDPE's without sacrificing the barrier properties of the resulting HDPE film while at the same time maintaining optimal process performance. The present invention addresses this need by incorporating peroxide into the HDPE resin or formula.

### SUMMARY

In one embodiment, the invention is a biaxially oriented blown film comprising: polyethylene having a density greater than about 0.950 g/cc; a molecular weight distribution, MWD, in the range of from about 2.0 to about 6.5; a rheological breadth parameter, a, that has been reduced by at least about 5%, but not more than 45%, by addition of peroxide to the polyethylene; said film having a thickness no greater than about 5 mil; and an oxygen transmission rate no greater than about 140 cm³/m²/day.

Another embodiment is a blown film comprising: polyethylene having a density greater than about 0.955 g/cc; a molecular weight distribution, MWD, in the range of from about 5.0 to about 6.5; a rheological breadth parameter, a, that has been reduced by at least about 10%, but not more than 45%, by addition of peroxide to the polyethylene; said film having a thickness no greater than about 5 mil; and an oxygen transmission rate no greater than about 140 cm³/m²/day.

A further embodiment is a process for producing a film comprising: combining at least polyethylene having a density of greater than about 0.950 g/cc, and a molecular weight distribution of less than about 7.0 with from about 5 ppm to about 75 ppm peroxide; producing film from the combination on a blown film line; and obtaining a film having a thickness of from about 5 mil to about 0.5 mil, and an oxygen transmission rate no greater than about 140 cm³/m²/day.

The films of any embodiments described herein may have a haze value of no greater than about 35% and/or a gloss value greater than about 40%.

The films of any embodiments described herein may be modified using peroxide is selected from the group consisting of: 2,5-di(t-butylperoxy)hexane; 1,1-bis(t-butylperoxy)-3,3,5-trimethyl cyclohexane; 1,1-bis(t-butylperoxy)-cyclohexane; 2,2-bis(t-butylperoxy)-octane; n-butyl-4,4-bis(t-butylperoxy)-valerate; di-t-butylperoxide; t-butyl-cumylperoxide; dicumylperoxide; αα″-bis(t-butyl-peroxyisopropyl)benzene; 2,5-dimethyl-2,5-di-di(t-butylperoxy)hexane; 2,5-dimethyl-2,5-di(benzoylperoxy)hexane; t-butylperoxyisopropylsopropylcarbonate, and combinations thereof. The amount of peroxide varies depending on the peroxide, but may, for example range from about 5 ppm to about 55 ppm.

In any of the embodiments described herein, peroxide treatment reduces the rheological breadth parameter, a, by at least about 20%, or 15%, but not more than 40%.

In any of the embodiments described herein the polyethylene may be unimodal, and/or have a melt index in the range of from about 1.0 dg/min to about 2.0 dg/min, measured at 190° C./2.16 kg. Also, the polyethylene may have a weight average molecular weight of less than about 120,000 but greater than about 50,000 and/or a molecular weight distribution (MWD) of from about 5 to about 6.5.

In any of the embodiments described herein the film thickness may be no greater than about 5 mil, and the film may have an oxygen transmission rate no greater than about 138 cm³/m²/day.

In any of the embodiments described herein, the film may be part of a multilayer film structure or laminate. Embodiments also include applications such as packaging, bags, wraps and liners for example.

### DRAWINGS

FIG. 1 is a graph showing the effect of peroxide level on oxygen transmission rate and breadth parameter, a, on an embodiment of polyethylene polymer.

### DESCRIPTION

Embodiments of the inventions will now be described in greater detail below, including specific embodiments, versions and examples, but the inventions are not limited to these embodiments, versions or examples, which are included to enable a person having ordinary skill in the art to make and use the inventions when the information is combined with available information and technology.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.113 etc., and the endpoints 0 and 10. Also, a range associated with chemical substituent groups such as, for example, “C₁ to C₅ hydrocarbons,” is intended to specifically include and disclose C₁ and C₅ hydrocarbons as well as C₂, C₃, and C₄ hydrocarbons.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Further as used in the specification and the appended claims, the singular forms “a,” “an,” and “the” include their plural referents unless the context clearly dictates otherwise. For example, references to an “extruder” or a “polymer,” are intended to include one or more extruders or polymers. References to a composition or process containing or including “an” ingredient or “a” step is intended to include other ingredients or other steps, respectfully, in addition to the one named.

HDPE is commercially available from several sources, for example: HDPE 6420 and HDPE 6410 from Total Petrochemicals USA, Inc.; L5885, M6210, M6020, and M6580 from Equistar Chemical Company; and 9656 and 9659 from Chevron Phillips Chemical Company. Methods for making these polymers are generally well known in the art and include slurry and gas phase processes in various types of reactors, under various conditions. Ziegler-Natta catalysts and methods for their use are well known as are metallocene and Chromium based catalysts and methods for their use.

Generally the molecular weight distribution (MWD) of the HDPE is less than about 7.0. (MWD=Mw/Mn as determined by GPC). In some embodiments, the MWD is in the range of from about 2.0 to about 7.0 or alternatively to about 6.5, or from about 2.0 to about 6.0. In other embodiments, the MWD is from about 3.0 to about 6.0, or alternatively from about 3.5 to about 6.0, or from about 4.0 to about 6.0, or from about 5.0 to about 6.5 or about 6.0. In an embodiment, the density of the HDPE is greater than about 0.950 g/cc. In some embodiments, the density of the HDPE is greater than about 0.955 g/cc, and in other embodiments, the density is greater than about 0.958 g/cc (density is determined per ASTM D792). The melt index (MI2 measured according to ASTM D-1238; 190° C./2.16 kg) of the HDPE is in the range of from about 10.0 dg/min to about 0.1 dg/min. In another embodiment the MI2 ranges from about 5.0 dg/min to about 0.5 dg/min, or from about 3.0 dg/min to about 1.0 dg/min. In another embodiment, the MI2 is in the range of from about 1.0 dg/min to about 2.0 dg/min. In an embodiment, the weight average molecular weight of the HDPE is less than about 120,000, but greater than about 50,000. In an embodiment, the HDPE is unimodal and can be a homopolymer or copolymer containing an ethylene content of from about 90 to about 100 mol %, with the balance, if any, being made up of C₃-C₈ alpha olefins, for example.

According to some embodiments, peroxide is added to the HDPE after production of the resin, but prior to extrusion or bubble formation. The amount of peroxide ranges from about 5 ppm to about 175 ppm, or alternatively from about 5 ppm to about 150 ppm, or from about 5 ppm to about 75 ppm, or from about 5 ppm to about 70 ppm, or from about 10 ppm to about 65 ppm, or from about 10 ppm to about 60 ppm, or from about 5 ppm to about 55 ppm, or from about 10 to about 50 ppm, or from about 10 ppm to about 45 ppm, or from about 5 ppm to about 40 ppm, or from about 5 ppm to about 35 ppm, or from about 5 ppm to about 30 ppm.

Any means of addition may be used. In one embodiment the peroxide is added to HDPE fluff or powder, or it can be added to the HDPE when it is molten. The peroxide can be added as a liquid or as a solid in master batch form. Thorough mixing should be achieved since, among other things, poor mixing can lead to gels.

In an embodiment, to ensure decomposition of the peroxide prior to extrusion, the extruder temperature should be held about 5% or more above the decomposition temperature of the peroxide.

Suitable peroxides are commercially available, for example, LUPEROX® (also known LUPERSOL) and as L101, L233 and L533 from Arkema. LUPEROX® 101 is 2,5-di(t-butylperoxy)-2,5-dimethyl hexane, L233 is ethyl 3,3-di(t-amylperoxy)butanoate, and L-533 is ethyl 3,3-di(t-butylperoxy)butyrate. Other examples of suitable peroxides include but are not limited to: 1,1-bis(t-butylperoxy)-3,3,5-trimethyl cyclohexane, 1,1-bis(t-butylperoxy)-cyclohexane, 2,2-bis(t-butylperoxy)-octane, n-butyl-4,4-bis(t-butylperoxy)-valerate, di-t-butylperoxide, t-butyl-cumylperoxide, dicumylperoxide, αα″-bis(t-butyl-peroxyisopropyl)benzene, 2,5-dimethyl-2,5-di-di(t-butylperoxy)hexane, 2,5-dimethyl-2,5-di(benzoylperoxy)hexane, and t-butylperoxyisopropylsopropylcarbonate, as well as others known to one skilled in the art. These may be used alone or in combination as a mixture of two or more. As used herein, “peroxide” encompasses one or more of these compounds. Other such peroxides known to one skilled in the art can be used.

HDPE may also be compounded with one or more other additives as is prior to extrusion. These include one or more of the following non-limiting examples: antioxidants, low molecular weight resin (Mw less than about 10,000 Daltons as described in U.S. Pat. No. 6,969,740), calcium stearate, heat stabilizers, lubricants, slip/anti-block agents, mica, talc, silica, calcium carbonate, weather stabilizers, Viton G B, Viton S C, Dynamar, elastomers, fluoroelastomers, any fluoropolymers, etc.

In one embodiment, the total antioxidant used is in the range of from about 400 ppm to about 1200 ppm. In another embodiment, the phosphite to phenolic additive ratio range is from about 0.5:1 to about 1.5:1.

One highly reliable, though indirect, method of determining and comparing bubble stability is to measure the rheological breadth, a, of the polymer. See U.S. Pat. Nos. 6,706,822; 6,147,167; 6,984,698; and U.S. Patent Application No. 2003/0030174. Rheological breadth refers to the breadth of the transition region between Newtonian and power-law type shear rate or frequency dependence of the viscosity. The rheological breadth is a function of the relaxation time distribution of the resin, which in turn is a function of a resin's molecular architecture. The rheological breadth parameter, a, is experimentally determined assuming Cox-Mertz rule by fitting flow curves generated using linear-viscoelastic dynamic oscillatory frequency sweep experiments with a modified Carreau-Yasuda (CY) model. According to the Cox-Mertz method, the magnitude of the complex viscosity is equal at equal values of radial frequency and shear rate. Cox, W. P. and Mertz, E. H., “Correlation of Dynamic and Steady Flow Viscosities,” J. Polym. Sci., 28 (1958) 619-621. Further details regarding the (CY) model may be found: Hieber, C. A., Chiang, H. A., Rheol. Acta., 28, 321 (1989); Hieber, C. A., Chiang, H. H., Polym. Eng. Sci., 32, 931, (1992).

η=η_{β}[1+(λγ)a]^{n-1/a}

where:
η=viscosity (Pa s);
γ=shear rate (1/s);
a=rheological breadth [describes the breadth of the transition region between Newtonian and power law behavior];
λ=relaxation time sec [describes the location in time of the transition region]; and
n=power law constant [defines the final slope of the high shear rate region].

To facilitate model fitting, the power law constant (n) is held at a constant value, e.g., n=0. An increase in the rheological breadth of a resin is seen as a decrease in the value of the breadth parameter, a, for a resin.

In some embodiments, film layers prepared according to the invention are characterized by a reduction in rheological breadth parameter, a, through use of peroxide by at least about 5% but not more than 45%, which results in an increase in rheological breadth and an increase in bubble stability that can be observed during processing. In another embodiment, the increase is at least about 10%, but not more than 40%, in another embodiment the increase is at least about 12%, but not more than 40%, in another embodiment, the increase is at least about 15%, but not more than 40%, and in another embodiment the increase is at least about 20%, but not more than 40%.

The effect of peroxide addition can also be observed as a reduction in MI2. Thus in some embodiments, the film layer is prepared from an HDPE having a MI2 that has been reduced through use of peroxide by at least about 1% but not more than about 50%, in another embodiment, the MI2 is reduced by at least about 1.5% but not more than about 50%, in another embodiment the MI2 is reduced by at least about 2% but not more than 50%.

In some embodiments, films prepared according to the invention have a thickness no greater than about 2 mil, and an oxygen transmission rate no greater than about 140 cm³/m²/day, or alternatively a thickness no greater than about 1.5 mil and an oxygen transmission rate no greater than about 138 cm³/m²/day, or a thickness no greater than about 1.25 mil, and an oxygen transmission rate no greater than about 135 cm³/m²/day, or a thickness no greater than about 1.0 mil, and an oxygen transmission rate no greater than about 135 cm³/m²/day. In one embodiment the thickness of the film layer is from about 0.5 mil to about 5 mil and the film layer has an oxygen transmission rate that is no greater than about 140 cm³/m²/day. In another embodiment, the film layer has a thickness of about 1 mil and an oxygen transmission rate that is no greater than about 138 cm³/m²/day.

Still another embodiment of the invention provides HDPE films with exceptional clarity, i.e. low haze, and/or having high gloss. For example, in some embodiments, the film layer will have a haze value (according to ASTM D1003) of no greater than about 20%, or alternatively about 35%, or about 30%. In some embodiments the gloss (according to ASTMD-2457-70) of the film layer is greater than about 20%, or alternatively about 30% or about 40%.

The films of the invention may be single or multi-layer films. For multilayered films, the additional layers may be made from any other material, for example homopolymers or copolymers such as propylene-butene copolymer, poly(butene-1), sytrene-acrylonitrile resin, acrylonitrile-butadiene-styrene resin, polypropylene, ethylene vinyl acetate resin, polyvinylchloride resin, poly(4-methyl-1-pentene), any low density polyethylene, and the like. Multilayer films of the invention may be formed using techniques and apparatus generally well known by one of the skill in the arts, such as, for example, co-extrusion, and lamination processes.

One embodiment of a multilayered film is a three layered polyethylene coextruded blown film converted into a pillow package wherein the core or middle layer comprises LLDPE, LDPE and/or a blend thereof; the outer layer comprises MDPE, the HDPE of the invention (i.e., for this embodiment, HDPE as describe herein blended with peroxide as described herein) and/or a blend thereof; and the inner layer comprises ethylene vinyl acetate, LLDPE and/or a blend thereof.

The core or middle layer of the above embodiment provides stiffness and puncture and tear resistance to the film and is a thickness in the range of about 1.0 mils to about 2.5 mils. The outer layer provides heat resistance and/or clarity to the film and is a thickness in the range of from about 0.1 mils to about 0.5 mils. The inner layer provides sealant function to the film and is a thickness in the range of from about 0.3 mils to about 0.6 mils. This particular embodiment is well suited for use in food service for institutional fresh produce packaging.

Any two or more of the above-described film-layer or film embodiments may be combined.

Another embodiment of the invention is directed to methods for producing blown films and film layers from HDPE. One such method is directed toward processes for producing a film comprising: a) combining at least polyethylene having a density of greater than about 0.950 g/cc; a molecular weight distribution of less than about 7.0 with from about 5 ppm to about 60 ppm peroxide thereby decreasing the rheological breadth parameter, a, of the HDPE by at least about 5% but not more than 45%: and b) producing film from the combination on a blown film line. As a result of this process, one or more films having one or more of the properties described above is obtained. One or more of these films, as described above, may be combined with one or more other films, during or after extrusion.

In one embodiment, the film of the invention is produced on a blown film line, such as an Alpine film line, in the pocket wherein the neck height is about zero inches, i.e., no neck. The air ring of the extruder can be opened to maximize cooling while maintaining a low air velocity thereby maintaining a low frost line and bubble stability. Higher frost line heights may be used to enhance barrier performance and are limited by bubble stability as defined by the resin formula and blown film line.

Other extruders are known and may be used, for example, Kiefel, Gloucester, Reifenhouser, Macchi, and CMG, as well as any other extruder known to one skilled in the art for such processes.

Any two or more of the above-described method or process embodiments may be combined.

Embodiments of the present invention may be used in various applications including, but not limited to: food packaging (including but not limited to those applications requiring adherence to 21 CFR 1771520); merchandise bags; shipping sacks; deli wraps; stretch wraps; shrink wraps; cereal liners; cookie and cracker over-wrap; bakery mixes, paper overwrap; cup overwrap; plate overwrap; envelope windows; release liners; stand-up bags; notion bags; millinery bags etc.

While the foregoing is directed to embodiments of the present invention, other and further embodiments of the invention may be devised without departing from the basic scope thereof, and the scope thereof is determined by the claims that follow.

### EXAMPLES

### Example 1

Resin fluff from commercially available barrier grade HDPE 6420 (Total Petrochemicals USA, Inc.) was used as the base material for the experiments. The fluff sample used in this work had an MI2 of 2.31 dg/min (ASTM D1238); a density of 0.962; and a MWD of about 5.4. The 6420 fluff was compounded with the typical additive package containing antioxidant and processing aid. In addition, Luperox L101, a dialkyl peroxide, was added at 0, 25, 50, 75, and 100 ppm levels.

A Brabender twin-screw (BB) was used to compound the samples. The conditions used were 50 RPM, 215° C. flat temperature profile, and 200-mesh screen pack at 1-mil thickness. Compounding was carried outwith 0, 25, 50, 75, and 100 ppm of Luperox 101.

Each of the samples were tested for MI2.16, rheology, and for oxygen transmission rate (02TR). Decreases in MI2 (i.e., fluff MI2 to pellet MI2) were checked to confirm the presence of peroxides in the material. At the highest level of peroxide (i.e., 100 ppm), there was a significant increase in the MI2 drop from 2.09 dg/min for the control to 1.10 dg/min. The shear response for each sample was characterized using the breadth parameter, ‘a’, from the Carreau-Yasuda fit of frequency sweep data for each sample. The breadth, parameter, ‘a’, for the 6420 materials dropped from 0.348 to 0.191, representing a 45% decrease by adding 100 ppm peroxide. This trend in MI2 and ‘a’ parameter as a function of peroxide level are listed in Table 1. The shift observed in MI2 and rheology confirms the change in molecular architecture, as measured using the breadth parameter “a,” from the presence of peroxy radicals. As a result, the modified resins have increased shear thinning as measured by a low breadth parameter, higher zero-shear viscosity and a longer relaxation time which translates to improved processability due to a higher melt strength and better bubble stability in blown film operations.

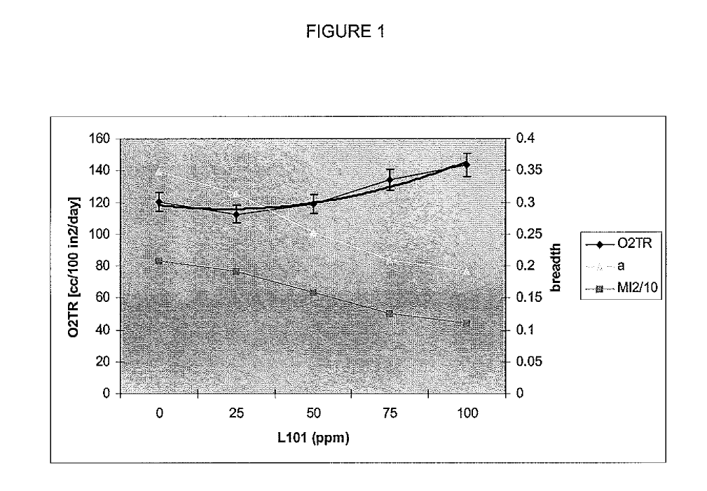

Stability in the film blowing process and film barrier characteristics were studied for the peroxide modified samples using a lab scale Brabender blown film line with a 0.9 mm die gap and 19 mm die diameter. Films were produced at a blow up ratio (BUR) of 2 having a 1-mil thickness for 02TR testing. The film 02TR results are listed in Table 1 and shown graphically in FIG. 1. It can be seen that at peroxide concentrations of up to 50 ppm, the barrier performance is preserved. In addition, a noticeable improvement in the bubble stability and melt strength was observed for the 50 ppm L101 sample over the 0 ppm baseline. It is also noted that at peroxide concentrations up to 50 ppm, the MWD remains unchanged while at concentrations above 50 ppm, a loss in Mz and consequently narrowing of the MWD is observed. See Table 2. This observation is consistent with degradation in the form of chain scission and could lead to compromised film properties.

For these experiments an optimum peroxide concentration of 50 ppm was determined to yield the highest shear response (lowest breadth parameter) while maintaining essentially equivalent barrier properties to the unmodified control. At this level of peroxide, the fluff to pellet MI2 drop was 31% (i.e., from 2.31 to 1.59) and a 27% drop in the breadth parameter relative to the control (i.e., from 0.348 to 0.253).

TABLE 1
Rheology and Barrier Properties as a function of peroxide level.

| | BB 6420 | BB 6420 | BB 6420 | BB 6420 | BB 6420 |
|---|---|---|---|---|---|
| Concentration (pure L101): | 0 ppm | 25 ppm | 50 ppm | 75 ppm | 100 ppm |
| Relaxation Time | 0.005 | 0.005 | 0.004 | 0.004 | 0.004 |
| Breadth Parameter “a” | 0.348 | 0.314 | 0.253 | 0.210 | 0.191 |
| MI2 (dg/min) | 2.09 | 1.91 | 1.59 | 1.26 | 1.1 |
| Ave O2TR (cc/100 in2/day) | 120 | 113 | 119 | 134 | 144 |
| O2TR Rep 1 | 123 | 118 | 117 | 135 | 145 |
| Ave Gauge Rep 1 | 1.2 | 1.2 | 1.2 | 1.1 | 1.2 |
| O2TR Rep 2 | 117 | 108 | 120 | 134 | 142 |
| Ave Gauge Rep 2 | 1.2 | 1.2 | 1.2 | 1.2 | 1.2 |

TABLE 2
MWD for Brabender compounded samples.

| | Control | Run 1 - 25 ppm | Run 2 - 50 ppm | Run 3 - 75 ppm | Run 4 - 100 ppm |
|---|---|---|---|---|---|
| Mn | 18,869 | 18,830 | 18,810 | 19,483 | 19,575 |
| Mw | 101,640 | 98,204 | 98,906 | 96,727 | 97,546 |
| Mz | 502,522 | 413,386 | 442,577 | 403,985 | 417,500 |
| Mp | 56,463 | 57,955 | 57,955 | 57,204 | 58,716 |
| D | 5.39 | 5.22 | 5.26 | 4.96 | 4.98 |
| D′ | 4.94 | 4.21 | 4.47 | 4.18 | 4.28 |
| Area | 1,115 | 1,066 | 1,086 | 1,108 | 1,048 |

### Example 2

Based on the results described in Example 1, a second experiment was carried out. HDPE 6420 fluff was compounded at conditions determined to yield the most bubble stability with no loss in barrier performance on a Leistritz twin-screw compounding line. This sample was then evaluated on a commercial scale Alpine blown film line. For comparison of relative stability, films were also made using commercial HDPE 6420 and other commercially available resins including Alathon L5885, and Marflex 9659. MI2, density and polydispersity for these resins are listed in Table 3.

TABLE 3
Resin characteristics.

| | HDPE | Alathon | Marflex |
|---|---|---|---|
| | 6420 | L5885 | 9659 |
| MI 2.16 kg (dg/min) | 2 | 0.85 | 1 |
| Density (g/cc) | 0.962 | 0.958 | 0.962 |
| Polydispersity | 5-6 | 7-8 | 7-8 |

HDPE 6420 fluff and additives as described in Example 1 were first compounded with 50 ppm of L101 on a Leistritz twin screw extruder at 243° C. using the same additive package as Example 1. At these conditions, 50 ppm peroxide resulted in an MI2 value of 1.1 dg/min representing a 52% fluff to pellet MI2 drop and exceeding the targeted amount. A drop in the level of peroxide to 30 ppm resulted in a near target MI2 drop of 33% and a final pellet MI2 of 1.55 dg/min.

Shear thinning data comparing the controls and the 30 ppm sample show a significant shift in the breadth parameter from 0.345 for the baseline with 0 ppm peroxide to 0.274 representing a 21% drop in the breadth parameter with 30 ppm peroxide (see Table 4). To evaluate the influence of this change in rheology on bubble stability, the 30 ppm sample along with the resins listed in Table 3 were run on an Alpine blown film line with a die gap of 1 mm and a die diameter of 120 mm, in the pocket at a 2.0 BUR. The general stability of the bubble at three take-up speeds (10, 20, and 30 meters/minute) was recorded, and is shown in Table 5.

The control resin, HDPE 6420 (without peroxide) was unstable at all three take-up speeds. Likewise, the Leistritz resin without peroxide was unstable at all but one of the conditions. However, the 30 ppm HDPE 6420 formulation was stable at all three conditions.

Finally, the Oxygen Transmission Rate (02TR) in cc/100 in2/day and Water Vapor Transmission Rate (WVTR) in g/100 in2/day was measured on films produced at 1, 2.5 and 5 mil films for the control samples, commercial grades and peroxide modified resin (30 ppm of peroxide). The data is given in Table 6. It can be seen that the improved processing performance achieved using peroxide, does not result in a compromise of barrier performance.

TABLE 2
MI2.16 and rheology for base line and peroxide modified resin.

| | HDPE | | |
|---|---|---|---|
| | 6420 | Leistritz | Leiatritz |
| | Concentration (L101) | | |
| | 0 ppm | 0 ppm | 30 ppm |
| Relaxation Time | 0.005 | 0.005 | 0.005 |
| Breadth Parameter “a” | 0.347 | 0.345 | 0.274 |
| MI2.16 (dg/min) | 2.00 | 1.89 | 1.55 |

TABLE 5
Stability for Materials Run on the Alpine Blown Film Line

| Take | HDPE | Leistritz | Leistritz | Alathon | Marflex |
|---|---|---|---|---|---|
| Away | 6420 | 6420 0 ppm | 6420 30 ppm | L5885 | 9659 |
| 10/min | unstable | unstable - | stable | stable | stable |
| | | touched iris | | | |
| 20/min | unstable | unstable | stable | stable | stable |
| 30/min | unstable - | stable | stable | stable | stable |
| | touched iris | | | | |

TABLE 6
Summary of OTR ans WVTR performance.

| | 1.0 mil | 2.5 mil | 5.0 mil |
|---|---|---|---|
| WVTR | (g/100-in2/day) | | |
| HDPE 6420 | 0.31 | 0.11 | 0.05 |
| Leistritz 0 ppm 6420 | 0.26 | 0.11 | 0.05 |
| Leistritz 30 ppm 6420 | 0.34 | 0.11 | 0.05 |
| Equistar L5885 | 0.33 | 0.11 | 0.07 |
| CPC 9659 | 0.35 | 0.09 | 0.05 |
| | 1.0 mil | 2.5 mil | 5.0 mil |
| O₂TR | (cc/100-in2/day) | | |
| HDPE 6420 | 156 | 43 | 29 |
| Leistritz 0 ppm 6420 | 122 | 48 | 29 |
| Leistritz 30 ppm 6420 | 160 | 39 | 25 |
| Equistar L5885 | 166 | 43 | 28 |
| CPC 9659 | 180 | 51 | 29 |

In the foregoing specification, the invention has been described with reference to specific embodiments thereof, and has been demonstrated as effective in providing methods for preparing polymers using peroxide initiators and other additives and articles made therefrom. However, it will be evident that various modifications and changes can be made thereto without departing from the scope of the invention as set forth in the appended claims. Accordingly, the specification is to be regarded in an illustrative rather than a restrictive sense. For example, specific combinations or amounts of and other components falling within the claimed parameters, but not specifically identified or tried in a particular polymer system, are anticipated and expected to be within the scope of this invention. Further, the methods of the invention are expected to work at other conditions, particularly temperature, pressure and proportion conditions, than those exemplified herein.

1. A biaxially oriented blown film comprising:
polyethylene having a density greater than about 0.950 g/cc; a molecular weight distribution, MWD, in the range of from about 2.0 to about 6.5;
a rheological breadth parameter, a, that has been reduced by at least about 5%, but not more than 45%, by addition of peroxide to the polyethylene;
said film having a thickness no greater than about 5 mil; and
an oxygen transmission rate no greater than about 140 cm³/m²/day.

2. The film of claim 1 having a haze value of no greater than about 35% and/or a gloss value greater than about 40%.

3. The film of claim 1 wherein the peroxide is selected from the group consisting of: 2,5-di(t-butylperoxy)hexane; 1,1-bis(t-butylperoxy)-3,3,5-trimethyl cyclohexane; 1,1-bis(t-butylperoxy)-cyclohexane; 2,2-bis(t-butylperoxy)-octane; n-butyl-4,4-bis(t-butylperoxy)-valerate; di-t-butylperoxide; t-butyl-cumylperoxide; dicumylperoxide; αα″-bis(t-butyl-peroxyisopropyl)benzene; 2,5-dimethyl-2,5-di-di(t-butylperoxy)hexane; 2,5-dimethyl-2,5-di(benzolyperoxy)hexane; t-butylperoxyisopropylsopropylcarbonate, and combinations thereof.

4. The film of claim 1 wherein the polyethylene is unimodal.

5. The film of claim 1 wherein the polyethylene has a melt index in the range of from about 1.0 dg/min to about 2.0 dg/min, measured at 190° C./2.16 kg.

6. The film of claim 1 having a thickness no greater than about 5 mil, and an oxygen transmission rate no greater than about 138 cm³/m²/day.

7. The film of claim 1 wherein the polyethylene has a weight average molecular weight of less than about 120,000 but greater than about 50,000.

8. The film of claim 1 wherein the polyethylene has a MWD of from about 5 to about 6.5.

9. The film of claim 1 wherein the rheological breadth parameter, a, has been reduced by at least about 20%, but not more than 40%.

10. A blown film comprising:
polyethylene having a density greater than about 0.955 g/cc;
a molecular weight distribution, MWD, in the range of from about 5.0 to about 6.5;
a rheological breadth parameter, a, that has been reduced by at least about 10%, but not more than 45%, by addition of peroxide to the polyethylene;
said film having a thickness no greater than about 5 mil; and
an oxygen transmission rate no greater than about 140 cm³/m²/day.

11. The film layer of claim 10 wherein the polyethylene has a melt index in the range of from about 2.0 dg/min to about 1.0 dg/min (measured at 190° C./2.16 kg).

12. A film having multiple layers wherein at least one of which comprises the film of claims 1 and/or 10.

13. A human or other animal food package or container comprising the film of claim 1 or 10.

14. A process for producing a film comprising:
combining at least polyethylene having a density of greater than about 0.950 g/cc, and a molecular weight distribution of less than about 7.0 with from about 5 ppm to about 75 ppm peroxide; producing film from the combination on a blown film line; and obtaining a film having a thickness of from about 5 mil to about 0.5 mil, and an oxygen transmission rate no greater than about 140 cm³/m²/day.

15. The process of claim 14 wherein the amount of peroxide added to the polyethylene is from about 5 ppm to about 55 ppm.

16. The process of claim 14 wherein the peroxide is selected from the group consisting of: 2,5-di(t-butylperoxy)hexane; 1,1-bis(t-butylperoxy)-3,3,5-trimethyl cyclohexane; 1,1-bis(t-butylperoxy)-cyclohexane; 2,2-bis(t-butylperoxy)-octane; n-butyl-4,4-bis(t-butylperoxy)-valerate; di-t-butylperoxide; t-butyl-cumylperoxide; dicumylperoxide; αα″-bis(t-butyl-peroxyisopropyl)benzene; 2,5-dimethyl-2,5-di-di(t-butylperoxy)hexane; 2,5-dimethyl-2,5-di(benzoylperoxy)hexane; t-butylperoxyisopropylsopropylcarbonate, and combinations thereof.

17. The process of claim 14 wherein the polyethylene is unimodal.

18. The process of claim 14 wherein the polyethylene has a melt index in the range of from about 1.0 dg/min to about 2.0 dg/min (measured at 190° C./2.16 kg).

19. The process of claim 14 wherein the polyethylene has a weight average molecular weight of less than about 120,000 but greater than about 50,000 and a molecular weight distribution (MWD) of from about 5.0 about 6.5.

20. The process of claim 14 wherein the rheological breadth parameter, a, of the polyethylene has been reduced by at least about 15%, but not more than 40% in response to the addition of the peroxide to the polyethylene.
